(19) United States
(12) Patent Application Publication
(10) Pub. No.: US 2012/0215853 A1
(43) Pub. Date: Aug. 23, 2012

(54) Managing Unwanted Communications Using Template Generation And Fingerprint Comparison Features

(75) Inventors: Manivannan Sundaram, Bothell, WA (US); Clinton Patrick Syrowitz, Bellevue, WA (US); Mauktik Gandhi, Redmond, WA (US); Charles W. Lamanna, Bellevue, WA (US)

(73) Assignee: MICROSOFT CORPORATION, Redmond, WA (US)

(21) Appl. No.: 13/029,281

(22) Filed: Feb. 17, 2011

(51) Int. Cl. G06F 15/16

(52) U.S. Cl. 709/206

(57) ABSTRACT

Unwanted communication detection and/or management features are providing, including using one or more commonality measures as part of generating templates for fingerprinting and comparison operations, but the embodiments are not so limited. An computing architecture of one embodiment includes components configured to generate templates and associated fingerprints for known unwanted communications, wherein the template fingerprints can be compared to unknown communication fingerprints as part of determining whether the unknown communications are based on similar templates and can be properly classified as unwanted or potentially unsafe communications for further analysis and/or blocking. A method of one embodiment operates to use a number of template fingerprints to detect and classify unknown communications as spam, phishing, and/or other unwanted communications.

### BACKGROUND

Spam can generally be described as the use of electronic messaging systems to send unsolicited and typically unwanted bulk messages. Spam can generally be characterized as encompassing some unwanted or unsolicited electronic communication. Spam encompasses many electronic services including e-mail spam, instant messaging spam, Usenet newsgroup spam, Web search engine spam, spam in blogs, wiki spam, online classified ad spam, mobile device spam, Internet forum spam, social networking spam, etc. Spam detection and protection systems attempt to identify and control spam communications.

Current spam detection systems use basic content filtering techniques like regular expressions or keyword matches as part of detecting spam. However, these systems are unable to catch all types of spam and other unwanted communications. For example, spammers commonly reuse HTML/literal templates for sending spam. Adding to the detection and elimination problem, spamming techniques are continuously evolving in attempts to bypass in-place spam detection and/or exclusion techniques. Moreover, scalability and performance issues come into the equation with the deployment of certain spam detection systems. Unfortunately, conventional methods and systems for identifying and excluding unwanted communications can be resource intensive and difficult to implement additional prevention measures.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide unwanted communication detection and/or management features, including using one or more commonality measures as part of generating templates for fingerprinting and comparison operations, but the embodiments are not so limited. In an embodiment, a computing architecture includes components configured to generate templates and associated fingerprints for known unwanted communications, wherein the template fingerprints can be compared to unknown communication fingerprints as part of determining whether the unknown communications are based on similar templates and can be properly classified as unwanted or potentially unsafe communications for further analysis and/or blocking A method of one embodiment operates to use a number of template fingerprints to detect and classify unknown communications as spam, phishing, and/or other unwanted communications. Other embodiments are included.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary computing architecture.

FIGS. 2A-2B illustrate an exemplary process of using a containment coefficient calculation as part of identifying spam communications.

FIG. 3 is a flow diagram depicting an exemplary process of identifying unwanted electronic communications.

FIG. 4 is a flow diagram depicting an exemplary process of processing and managing unwanted electronic communications.

FIGS. 5A-5D depict examples of using messages in part to generate a template for fingerprinting and use in message characterization operations.

FIGS. 6A-6C depict examples of using messages in part to generate a template for fingerprinting and use in message characterization operations.

FIG. 7 is a flow diagram depicting an exemplary process of processing and managing unwanted electronic communications.

FIG. 8 is a block diagram depicting aspects of an exemplary spam detection system.

FIG. 9 is a block diagram depicting aspects of an exemplary spam detection system.

FIG. 10 is a block diagram illustrating an exemplary computing environment for implementation of various embodiments described herein.

### DETAILED DESCRIPTION

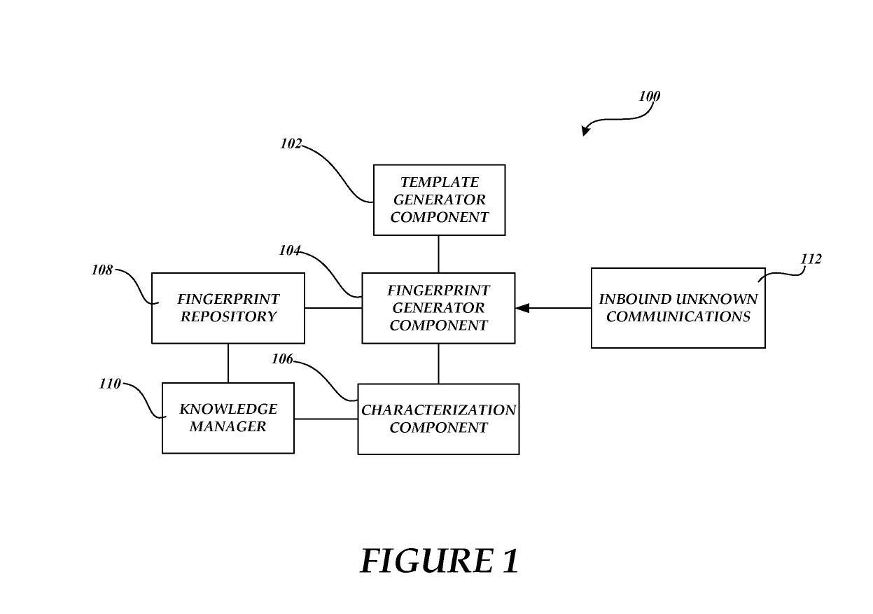

FIG. 1 is a block diagram of an exemplary computing architecture 100 that includes processing, memory, and other components/resources that provide communication processing operations, including functionality to process electronic messages as part of preventing unwanted communications from being delivered and/or clogging up a communication pipeline. For example, memory and processor based computing systems/devices can be configured to provide message processing operations as part of identifying and/or preventing spam and other unwanted communications from being delivered to recipients.

In an embodiment, components of the architecture 100 can be used as part of monitoring messages over a communication pipeline, including identifying unwanted communications based in part on one or more known unwanted communication template fingerprints. For example, template fingerprints can be generated and grouped according to various factors, such as by a known spamming entity. Known unwanted communication template fingerprints can be representative of a defined group or grouping of known unwanted communications. As described below, false and/or negative feedback communications can be used as part of maintaining aspects of a template fingerprint repository, such as deleting/removing and/or adding/modifying template fingerprints.

In one embodiment, templates can be generated based in part on extracting first portions of a number of unwanted communication based in part on a first commonality measure and extracting second portions of the number of unwanted communication based in part on a second commonality measure. For example, a template generating process can operate to identify and extract portions of a first group of electronic messages based in part on first commonality measure that indicates little or no commonality between the identified portions of the first group of electronic messages. Continuing the example, the template generating process can also operate to identify and extract portions of a second group (e.g., spanning multiple groups) of electronic messages based in part on a second commonality measure that indicates high or significant commonality (e.g., very common markup structure across multiple messages) between the identified portions of the second group of electronic messages. Once the portions have been extracted, fingerprints can be generated for use in detecting unwanted communications, as discussed below.

In another embodiment, templates can be generated based in part on the use of custom string parsers configured to extract defined portions of a number of unwanted communications including hypertext markup language (HTML) as part of generating templates for fingerprinting. A template generator of an embodiment can be configured to extract all literals and markup attributes from an unwanted communication data structure, exposing basic tags (e.g., <html>, <a>, <table>, etc.). For example, a template generator can use custom parsers to remove literals from MIME message portions and then apply regular expressions to remaining portions to extract pure tags as part of generating templates for fingerprinting and use in message characterization operations.

With continuing reference to FIG. 1, components of the architecture 100 monitor one or more electronic communications, such as a dedicated message communication pipeline for example, as part of identifying or monitoring unwanted electronic communications, such as spam, phishing, and other unwanted communications. As discussed below, components of the architecture 100 are configured to generate templates and template fingerprints for one or more known unwanted electronic communications. The template fingerprints for known unwanted electronic communications can be used as part of characterizing unknown electronic communications as safe or unsafe. For example, template fingerprints for known unwanted electronic communications can be stored in computer memory (e.g., remote and/or local) and compared with unknown message fingerprints as part of characterizing or identifying unknown electronic messages as unwanted electronic communications (e.g., spam messages, phishing messages, etc.).

As shown in FIG. 1, the architecture 100 of an embodiment includes a template generator component or template generator 102, a fingerprint generator component or fingerprint generator 104, a characterization component 106, a fingerprint repository 108, and/or a knowledge manager component or knowledge manager 110. As shown, and described further below, components of the architecture 100 can be used to monitor and process aspects of inbound unknown electronic communications 112 over a communication pipeline (e.g. simple mail transport (SMTP) pipeline), but are not so limited.

As an example of an unknown message characterization operation, a collection of e-mail messages can be grouped together based on indications of a spam campaign (done via source IP address, source domain, similarity scoring, etc.) and template processing operations can be used to provide templates for fingerprinting. For example, Microsoft Forefront Online Protection for Exchange (FOPE) maintains a list of IP addresses that are known to send spam, wherein templates can be generated according to IP address groupings. In one embodiment, messages associated with the known IP addresses are used to capture live spam emails for use by the template generator 102 when generating templates for fingerprinting.

The template generator 102 is configured to generate electronic templates based in part on aspects of one or more source communications, but is not so limited. For example, the template generator 102 can generate unwanted communication templates based in part on aspects of known spam or other unwanted communications composed of a markup language and data (e.g., HTML template including literals). The template generator 102 of an embodiment can generate electronic templates based in part on aspects of one or more electronic communications, including the use of one or more commonality measures to identify communication portions for extraction. Remaining portions can be fingerprinted and used as part of identify unwanted communications or unwanted communication portions.

The template generator 102 of one embodiment can operate to generate unwanted communication templates by extracting first communication portions based in part on a first commonality measure and extracting second communication portions based in part on a second commonality measure. Once the portions have been extracted, the fingerprinting component 104 can generate fingerprints for use in detecting unwanted communications, as discussed below. For example, the template generator 102 can operate to identify and extract portions of a first group of electronic messages based in part on first commonality measure, indicating little or no commonality between identified portions of the first group of electronic messages (e.g., majority of e-mails in a group do not contain identified first portions, grouped according to know spamming IP addresses).

Commonality can be identified based in part on the inspection of message HTML and literals, a collection of the disjoint “tuples” or word units of a message using a lossless set intersection, and/or other automatic methods for identifying differences between the messages. Continuing the example above, the template generating process can also identify and extract portions of a second group (e.g., spanning multiple groups) of electronic messages based in part on a second commonality measure, indicating high or significant commonality between the associated portions of the second group of electronic messages.

As one example, very common portions can be identified using the second commonality measure defined as message parts that occur in ten (10) percent of all messages and include an inverse document frequency (IDF) measure beyond a basic value (e.g. <!DOCTYPE html PUBLIC “-//W3C//DTD XHTML 1.0 Transitional//EN” “http://www.w3.org/TR/xhtml1/DTD/xhtml1-transitional.dtd”>). Note that these very common identified portions likely span multiple groups and/or repositories. In one embodiment, the very common portions can be identified by compiling a standard listing or by dynamically generating a list based on sample messages, thereby improving the selectivity of the fingerprinting process. Any remaining portions (e.g., HTML and literals) can be defined as a template for fingerprinting by the fingerprinting component 104.

In another embodiment, the template generator 102 can operate to generate templates based in part on the use of custom string parsers configured to extract defined portions of a number of unwanted communications as part of generating templates for fingerprinting. A template generator of an embodiment can be configured to extract all literals and HTML attributes from an unwanted communication data structure and leave basic HTML tags (e.g., <html>, <a>, <table>, etc.). For example, the template generator can use custom parsers to remove literals from text of MIME message portions and then apply regular expressions to remaining portions to extract pure tags as part of generating templates for fingerprinting and use in message characterization operations.

The fingerprinting component 104 is configured to generate electronic fingerprints based in part on an underlying source, such as a known spam template or unknown inbound message for example, using a fingerprinting algorithm. The fingerprinting component 104 of an embodiment operates to generate electronic fingerprints based in part on a hashing technique and aspects of electronic communications including aspects of generated electronic templates classified as spam and at least one other unknown electronic communication.

In one embodiment, the fingerprinting component 104 can generate fingerprints for use in determining a similarity measure between known and unknown communications using a minwise hashing calculation. Minwise hashing of an embodiment involves generating sets of hash values based on word units of electronic communications, and using selected hash values from the sets for comparison operations. B-bit minwise hashing includes a comparison of a number of truncated of bits of the selected values. Fingerprinting new, unknown messages does not require removal or modification of any portions before fingerprinting due in part to the asymmetric comparison provided by using a containment factor or coefficient, discussed further below.

A type of word unit can be defined and used as part of a minwise hashing calculation. A choice of word unit corresponds to a unit used in a hashing operation. For example, a word unit for hashing can include a single word or term, or two or more consecutive words or terms. A word unit can also be based on a number of consecutive characters. In such an embodiment, the number of consecutive characters can be based on all text characters (such as all ASCII characters), or the number of characters can exclude non-alphabetic or non-numeric characters, such as spaces or punctuation marks.

Extracting word units can include extracting all text within an electronic communication, such as an e-mail template for example. Extraction of word pairs can be used as an example for extracting word units. When word pairs are extracted, each word (except for the first word and the last word) can be included in word pairs. For example, consider a template that begins with the words “Patent Disclosure Document. This is a summary paragraph, Abstract, Claims, etc.” The word pairs for this template include “Patent Disclosure”, “Disclosure Document”, “Document This”, “This is”, etc. Each term appears as both a first term in a pair and a second term in a pair to avoid the possibility that similar messages might appear different due to being offset by a single term.

A hash function can be used to generate a set of hash values based on extracted word units. In an embodiment where the word unit is a word pair, the hash function is used to generate a hash value for each word pair. Using a hash function on each word pair (or other word unit parsing) results in a set of hash values for an electronic communication. Suitable hash functions allow word units to be converted to a number that can be expressed as an n-bit value. For example, a number can be assigned to each character of a word unit, such as an ASCII number.

A hash function can then be used to convert summed values into a hash value. In another embodiment, a hash value can be generated for each character, and the hash values summed to generate a single value for a word unit. Other methods can be used such that the hash function converts a word unit into an n-bit value. Hash functions can also be selected so that the various hash functions used are min-wise independent of each other. In one embodiment, several different types of hash functions can be selected, so that the resulting collection of hash functions is approximately min-wise independent.

Hashing of word units can be repeated using a plurality of different hash functions such that each of the plurality of hash functions allows for creation of different set of hash values. The hash functions can be used in a predetermined sequence, such that a same sequence of hash functions can be used on each message being compared. Certain hash functions may differ based on the functional format of the hash function. Other hash functions may have similar functional formats, but include different internal constants used with the hash function. The number of different hash functions used on a document can vary, and can be related to the number of words (or characters) in a word unit. The result of using the plurality of hash functions is a plurality of sets of hash values. The size of each set is based on the number of word units. The number of sets is based on the number of hash functions. As noted above, the plurality of hash functions can be applied in a predetermined sequence, so that the resulting hash value sets correspond to an ordered series or sequence of hash value sets.

In an embodiment, for each set of hash values, a characteristic value can be selected from the set. For example, one choice for a characteristic value can be the minimum value from the set of hash values. The minimum value from a set of numbers does not depend on the size of the set or the location of the minimum value within the set of numbers. The maximum value of a set could be another example of a characteristic value. Still another option can be to use any technique that is consistent in producing a total ordering of the set of hash values, and then selecting a characteristic value based on aspects of the ordered set.

In one embodiment, a characteristic value can be used as the basis for a fingerprint value. A characteristic value can be used directly, or transformed to a fingerprint value. The transformation can be a transformation that modifies the characteristic value in a predictable manner, such as performing an arithmetic operation on the characteristic value. Another example includes truncating the number of bits in the characteristic value, such as by using only the least significant b bits of an associated characteristic value.

Fingerprint values generated from a group of hash functions can be assembled into a set of fingerprint values for a message, ordered based on the original predetermined sequence used for the hash values. As described below, fingerprint values representative of a message fingerprint can be used to determine a similarity value and/or containment coefficient for electronic communications. Fingerprints comprising an ordered set of fingerprint values can be easily stored in the fingerprint repository 108 and compared with other fingerprints, including fingerprints unknown message. Storing fingerprints rather than underlying sources (e.g., templates, original source communications, etc.) requires the use of much less memory and fewer processing demands. In an embodiment, hashing operations are not reversible. For example, original text cannot be reconstructed from resulting hashes.

The characterization component 106 of one embodiment is configured to perform characterization operations using electronic fingerprints based in part on a similarity and containment factor process. In an embodiment, the characterization component 106 uses a template fingerprint and an unknown (e.g., new spam/phishing campaign) communication fingerprint to identify and vet spam, phishing, and other unwanted communications. As described above, a word unit type is used as part of the fingerprinting process. A shingle represents n contiguous words of some reference text or corpus. Research has indicated that a set of shingles can accurately represent text when performing set similarity calculations. As an example, consider the message “the red fox runs far.” This would produce a set of shingles or word units as follows: {“the red”, “red fox”, “fox runs”, “runs far”}.

The characterization component 106 of one embodiment uses the following algorithm as part of characterizing unknown communication fingerprints, where:

Fingerprint: the fingerprint that represents Sₜ for purposes of template detection and effectively represents a sequence of hash values.

Fingerprint (i): returns the i^{th} value in the fingerprint.

WordUnitCountₜ: the number of word units contained in a template (e.g., HTML template) dependent on template generation method.

S_{c}: the set of word units in an unknown communication (e.g., live e-mail).

R: R represents the set resemblance or similarity.

hash: hash is a unique hash function with random dispersion.

min: min(S) finds the lowest value in S.

bb(b,v₁,v₂): is equal to one (1) if last b bits of v₁ and v₂ are equal; otherwise, equal to zero (0).

$$\begin{matrix}R = Probability ( {Fingerprint}_{t} ( 0 ) = min ( hash ( {S}_{c} ) ) ) \\ \approx \frac{1}{k} * {\sum }_{j = 1}^{k} \{ bb ( b , {Fingerprint}_{t} ( j ) , min ( {hash}_{j} ( {S}_{c} ) ) ) \}\end{matrix}$$

$$R \approx \frac{1}{k} * {\sum }_{j = 1}^{k} \{ bb ( b , {Fingerprint}_{t} ( j ) , min ( {hash}_{j} ( {S}_{c} ) ) ) \}$$

Cᵣ: the Containment Coefficient or fraction of one document, file, or other

structure found in another document, file, or other structure

$${C}_{r} = \frac{\frac{R}{1 + R} * ( {WordUnitCount}_{t} + \vert {S}_{c} \vert )}{{WordUnitCount}_{t}}$$

$${C}_{r} \geq threshold {}^{yields} {S}_{t} ⊆ {S}_{c}$$

and the text of Sₜ is therefore a subset of S_{c}

If Sₜ⊂S_{c}, then the unknown communication is based on the template and can be identified as unwanted (e.g., mail headers can be stamped accordingly).

An exemplary unique hashing algorithm with random dispersion can be defined below:

1) Use message-digest algorithm 5 (Md5) and a corresponding word unit to produce a 128 bit integer representation of the word unit.

2) Take 64 bits from this 128 bit representation (e.g., the 64 least significant bits).

3) Take an established large prime number “seed” from a consistent collection of large prime numbers (e.g., hash) would use the jth prime number seed from the collection).

4) Take an established small prime number “seed” from a collection (following the same process as (1)).

5) Take the lower 32 bits of the 64 bits from the Md5.

6) Multiply the value from (5) by the little prime number and take the 59 most significant bits; multiple the value by (5) by the little prime number and take the least significant 5 bits; “OR” these values.

7) Multiple the value from (6) by the large hash number from (3).

8) Take the upper 32 bits of the 64 bits from the Md5 and multiply that by the little prime number and take the most significant 59 bits; multiply the upper 32 bits of the 64 bits from the Md5 and the little prime number and take the 5 least significant bits; “OR” these values.

9) Add the values from (6) and (8) to produce a minwise independent value.

The hashing function can be deterministically reused to produce minwise independent values by modifying the prime number seeds from (3) and (4) above.

An example of the hashing function as implemented in F# can be seen below:
let termHash (seedIndex:int, termValue:uint64)=
let hashStarter=primeNumbers.[seedIndex]
let randomSeed=littlePrimeNumbers.[seedIndex]
let lowerBits=termValue &&& 4294967295UL//0xFFFFFFFF
let op1=hashStarter*(((randomSeed*(termValue>>>32))>>>5)|∥((randomSeed*(termValue>>>32))<<<59))+(termValue>>>32)
hashStarter*((randomSeed*lowerBits)>>>5)|∥((randomSeed*lowerBits)<<<59)+lowerBits.

When the containment coefficient Cᵣ is greater than a threshold value, the smaller Sₜ can be considered to be a subset (or substantially a subset) of S_{c}. If Sₜ is a subset or substantially a subset of S_{c}, then Sₜ can be considered as a template for S_{c}. The threshold value can be set to a higher or lower value, depending on the desired degree of certainty that Sₜ is a subset of S_{c}. A suitable value for a threshold can be at least about 0.50, or at least about 0.60, or at least about 0.75, or at least about 0.80, as a few examples. Other methods are available for determining a fingerprint and/or a similarity, and using these values to determine a containment coefficient.

Other variations on the minwise hashing procedure described above may be available for calculating fingerprints. Another option could be to use other known methods for calculating a resemblance, such as “Locality Sensitive Hashing” (LSH) methods. These can include the 1-bit methods known as sign random projections (or simhash), and the Hamming distance LSH algorithm. More generally, other techniques that can determine a Jaccard Similarity Coefficient can be used for determining the set resemblance or similarity. After determining a set resemblance or similarity, a containment coefficient can be determined based on the cardinality of the smaller and larger sets.

The fingerprint repository 108 of an embodiment includes memory and a number of stored fingerprints. The fingerprint repository 108 can be used to store electronic fingerprints classified as spam, phishing, and/or other unwanted communications for use in comparison with other unknown electronic communications by the characterization component 106 when characterizing unknown communications, such as unknown e-mails being delivered using a signal communication pipeline. The knowledge manager 110 can be used to manage aspects of the fingerprint repository 108 including using false positive and negative feedback communications as part of maintaining an accurate collection of known unwanted communication fingerprints to increase identification accuracy of the characterization component 106.

The knowledge manager 110 can provide a tool for spam analysts to determine if the false positive/false negative (FP/FN) feedback was accurate (for example, a lot of people incorrectly report newsletters as spam). After validating that the messages are truly false positives or false negatives, the anti-spam rules can be updated to improve characterization accuracy. Thus, analysts can now specify an HTML/literal template for a given spam campaign reducing the time and improving spam identification accuracy. Rule updates and certification can be used to validate that updated rules (e.g., regular expressions and/or templates) do not adversely harm the health of a service (e.g., cause a lot of false positives). If the rule passes the validation, it can then be released to production servers for example.

The functionality described herein can be used by or part of a hosted system, application, or other resource. In one embodiment, the architecture 100 can be communicatively coupled to a messaging system, virtual web, network(s), and/or other components as part of providing unwanted communication monitoring operations. An exemplary computing system includes suitable processing and memory resources for operating in accordance with a method of identifying unwanted communications using generated template and unknown communication fingerprints. Suitable programming means include any means for directing a computer system or device to execute steps of a method, including for example, systems comprised of processing units and arithmetic-logic circuits coupled to computer memory, which systems have the capability of storing in computer memory, which computer memory includes electronic circuits configured to store data and program instructions. An exemplary computer program product is usable with any suitable data processing system. While a certain number and types of components are described above, it will be appreciated that other numbers and/or types and/or configurations can be included according to various embodiments. Accordingly, component functionality can be further divided and/or combined with other component functionalities according to desired implementations.

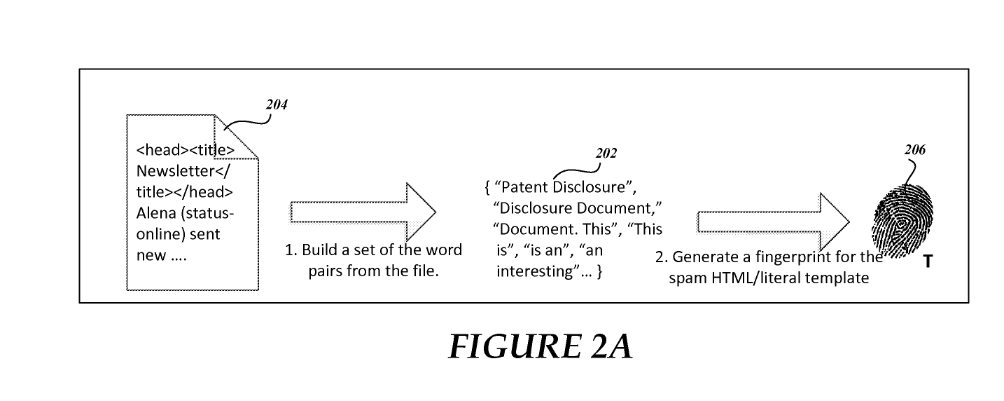

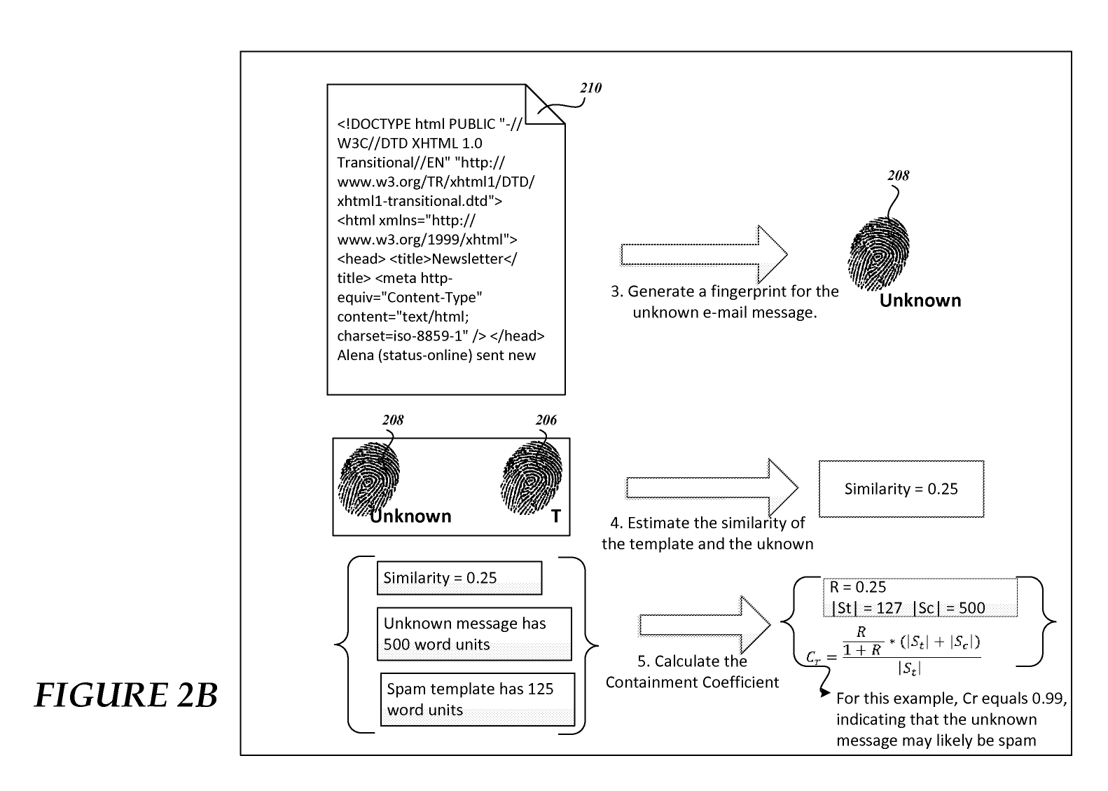

FIGS. 2A-2B illustrate an exemplary process of using a containment coefficient calculation as part of identifying spam communications. As shown in FIG. 2A, a set of word pairs 202 are generated based in part on aspects of an underlying source or file 204 (e.g., a template generated from a known HTML spam template). A template fingerprint 206 can then be generated using the set of word pairs 202. It will be appreciated that a collection of spam fingerprints can be generated, stored, and/or updated in advance of characterization operations. As shown in FIG. 2B, a fingerprint 208 can also be generated for an unknown communication 210, such as an active e-mail message being delivered using an SMTP pipeline. The template fingerprint 206 and fingerprint 208 are then processed as part of estimating similarity between the template and the unknown communication. Using the similarity value, the containment coefficient can be determined and the characterization of the unknown communication as spam or not spam can then be determined therefrom in conjunction with a triggering threshold that identifies likely spam communications.

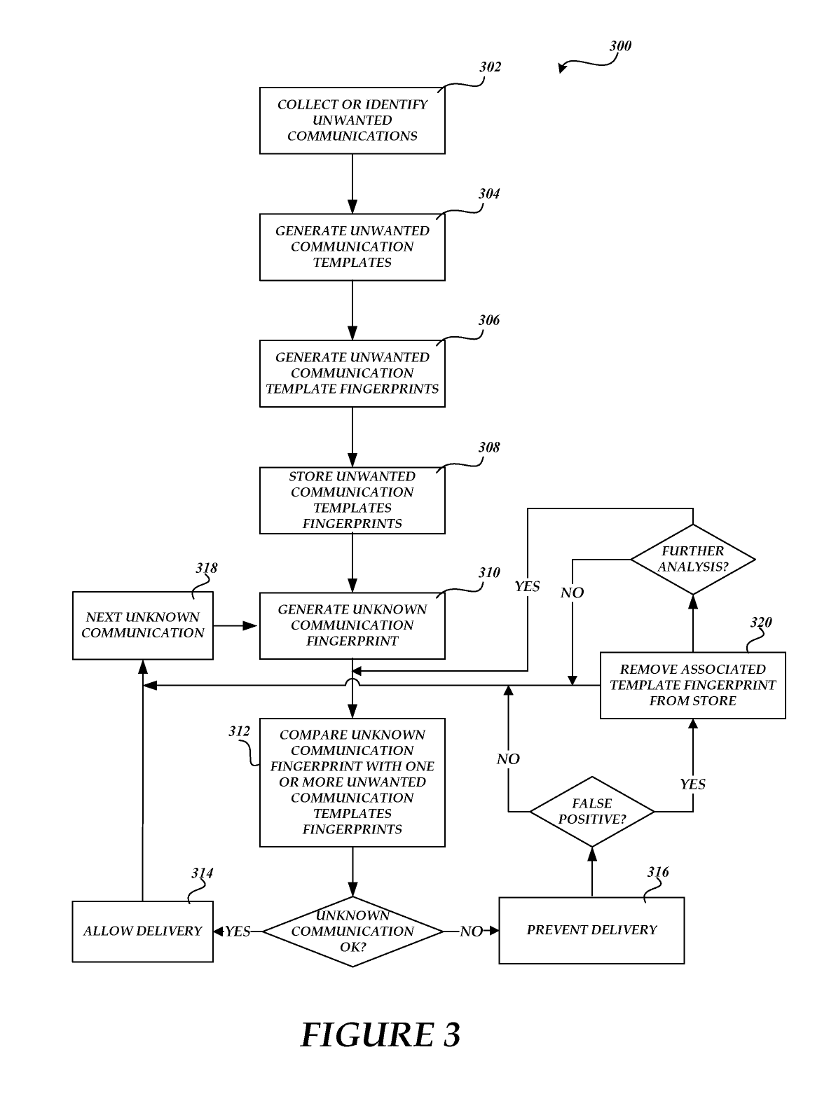

FIG. 3 is a flow diagram depicting an exemplary process 300 of identifying unwanted electronic communications, such as spam, phishing, or other unwanted communications. At 302, the process 300 operates to identify and/or collect unwanted communications, such as HTML spam templates for example, to be used as part of generating comparison templates. At 304, the process 300 operates to generate unwanted communication templates based in part on the unwanted communications. The process 300 of one embodiment at 304 operates to generate unwanted communication templates based in part on the use of one or more commonality measures used to extract portions from each unwanted communication (or groups) when generating an associated template.

At 306, the process 300 operates to generate an unwanted communication template fingerprint for the generated unwanted communication template. In one embodiment, a b-bit minwise technique is used to generate fingerprints. At 308, unwanted communication template fingerprints are stored in a repository, such as a fingerprint database for example. At 310, the process 300 operates to generate a fingerprint for an unknown communication, such as an unknown e-mail message for example. At 312, the process 300 operates to compare the unwanted communication template fingerprints and the unknown communication fingerprint. Based in part on the comparison, the unknown communication can be characterized or classified as not unwanted and allowed to be delivered at 314, or classified as unwanted and prevented from being delivered at 316. For example, a previously unknown message determined to be spam can be used to block the associated e-mails, and the sender(s), service provider(s), and/or other parties can be notified of the unwanted communication, including a reason to restrict future communications without prior authorization.

As described above, feedback communications can be used to reclassify an unwanted communication as acceptable, and the process 300 can operate to remove any associated unwanted communication fingerprint from the repository at 320, and move onto processing another unknown communication at 318. However, if an unknown communication has been correctly identified as spam, the process proceeds to 318. While a certain number and order of operations is described for the exemplary flow of FIG. 3, it will be appreciated that other numbers and/or orders can be used according to desired implementations. Other embodiments are available.

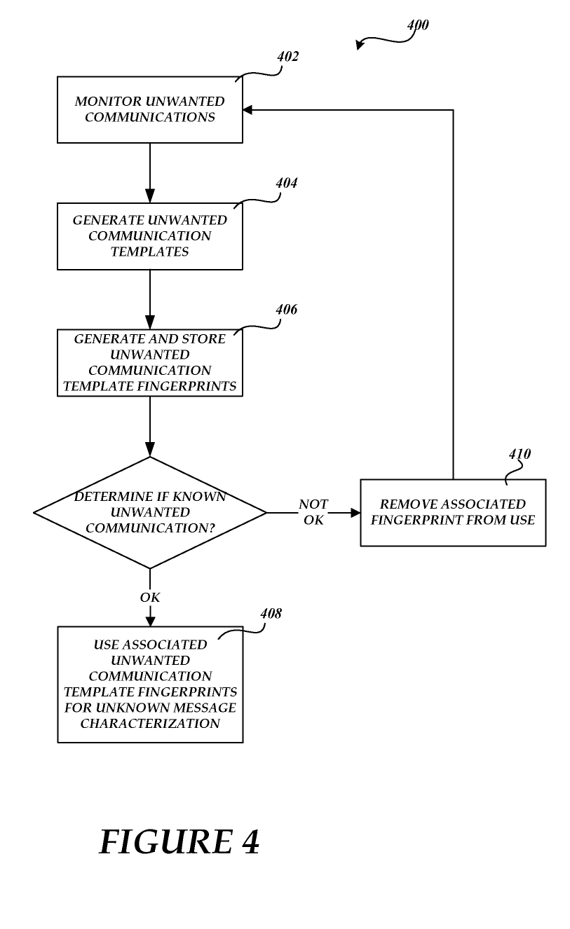

FIG. 4 is a flow diagram depicting an exemplary process 400 of processing and managing unwanted electronic communications. The process 400 at 402 operates to monitor a communication pipeline for unwanted communications, such as unwanted electronic messages for example. At 404, the process 400 operates to generate unwanted communication templates. In one embodiment, the process 400 at 404 operates to extract first portions of known spam messages of a first group (e.g., a first IP address grouping) based in part on a first commonality measure and second portions of known spam messages of a second group (across all or a majority of groups for example) based in part on a second commonality measure. For example, an anti-spam engine can be used to accumulate IP addresses of known spammers, wherein associated spam communications can be used to generate unwanted communication templates for fingerprinting and comparing.

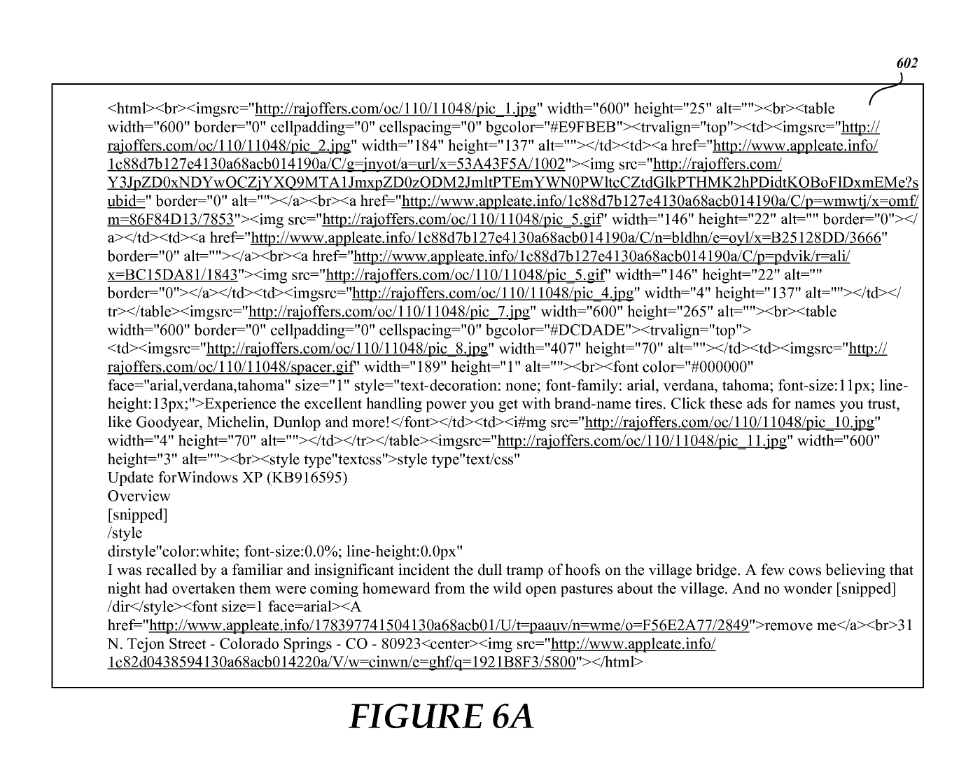

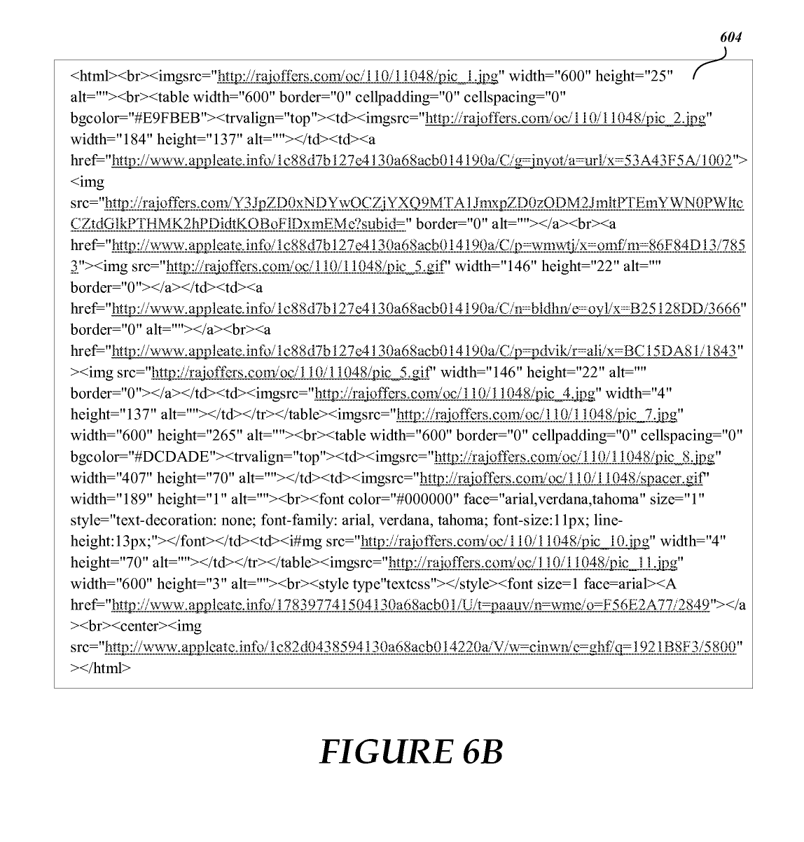

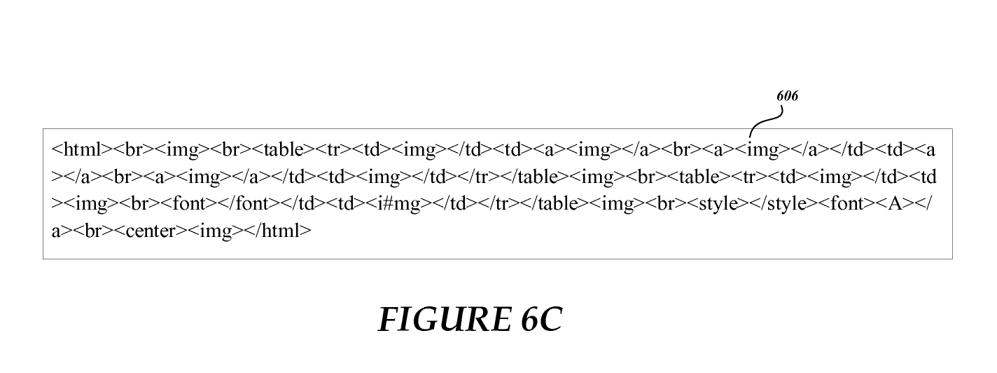

In another embodiment, the process 400 at 404 can be used to extract HTML attributes and literals as part of generating templates consisting essentially of HTML tags. In one embodiment, the process 400 at 404 uses remaining HTML tags to form a string data structure for each template. The information contained in the tag string or generated template provides a similarity measure for the HTML template for use in detecting unwanted messages (e.g., similarity across a spam campaign). Such a template includes relatively static HTML for each spam campaign, since the HTML requires a structure and cannot be easily randomized. Moreover, the literals can be ignored since this text can be randomized (e.g., via newsreader, dictionary, etc.). Such a string-based template can also provide exploitation of malformed headers (see “<i#mg>” in FIG. 6C). Particularly, the position and malformation of the tag within the exemplary template is most likely unique to the particular spam campaign. A tag may also be entered incorrectly due to a typo by the author or intentionally broken to avoid rendering (e.g., hidden data/invisible to the reader/recipient). A determination of spam can be confirmed manually or based on some volume or other threshold.

At 406, the process 400 operates to generate and/or store unwanted communication fingerprints in computer memory. At 408, the template fingerprints can be used as a comparative fingerprint along with unknown communication fingerprints to identify unwanted communications. In one embodiment, a validation process is first used to verify that the associated unwanted communication or communication are actually known as being unwanted before using the template fingerprint as a comparative fingerprint along with an unknown communication fingerprint to identify unwanted communications. Otherwise, at 410, the template fingerprint can be removed from memory if the unwanted communication is determined to be an acceptable communication (e.g., not spam). While a certain number and order of operations is described for the exemplary flow of FIG. 4, it will be appreciated that other numbers and/or orders can be used according to desired implementations.

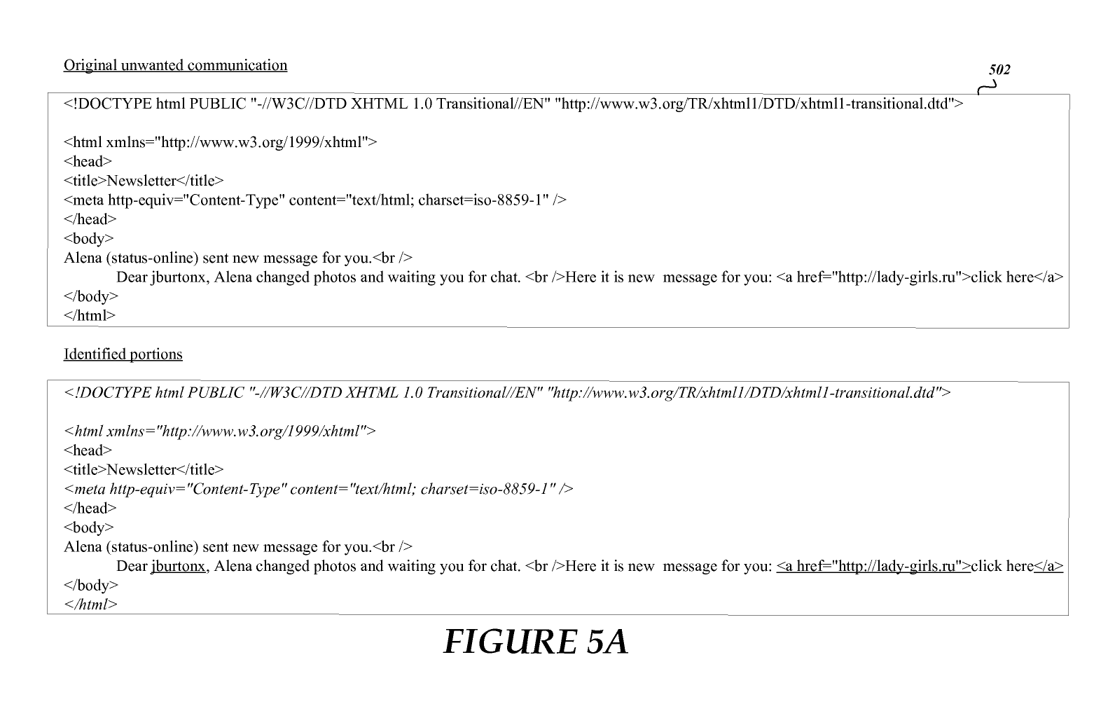

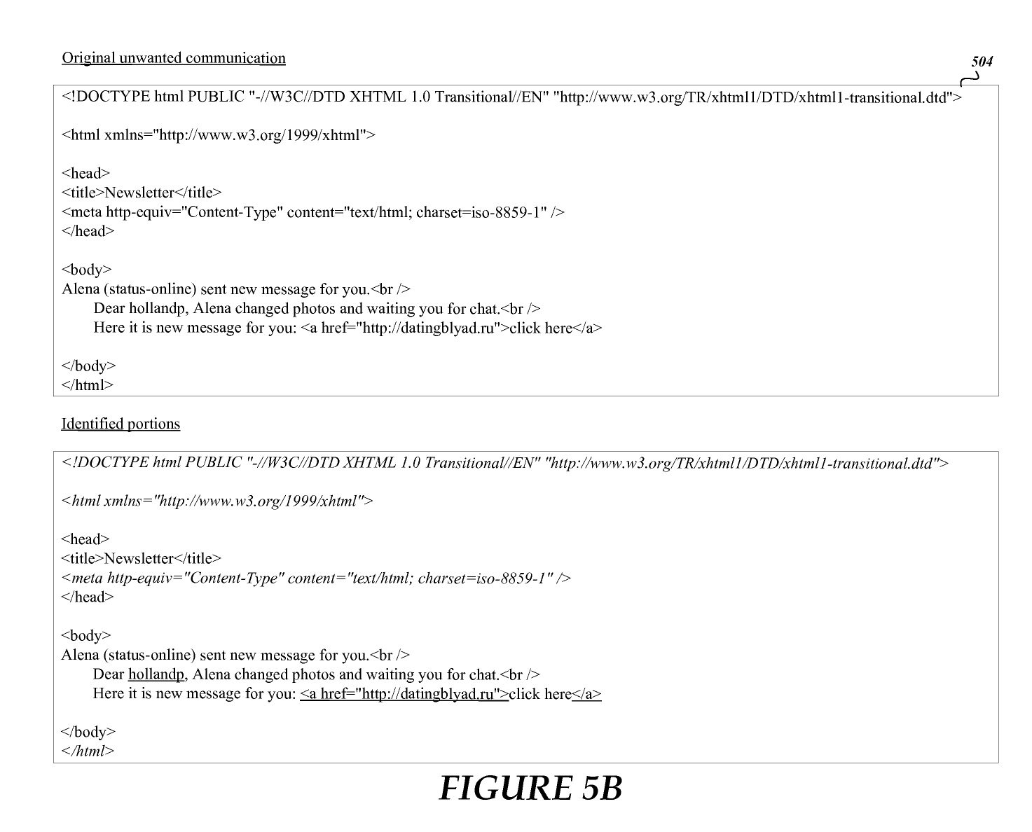

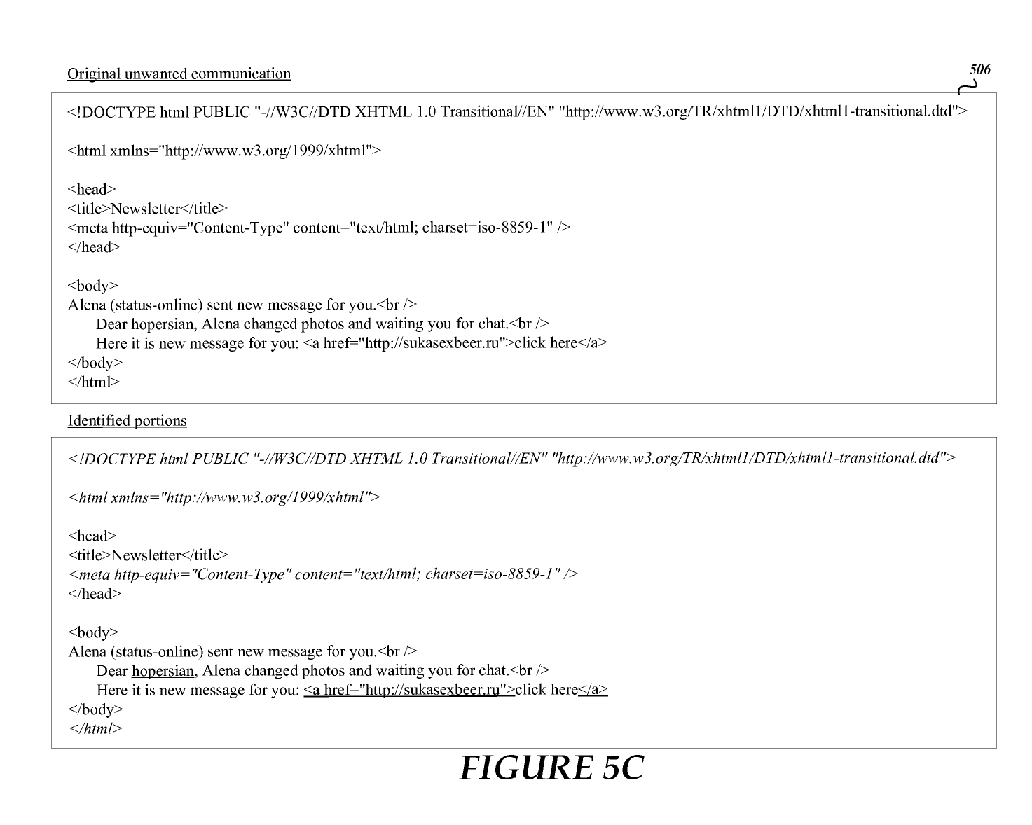

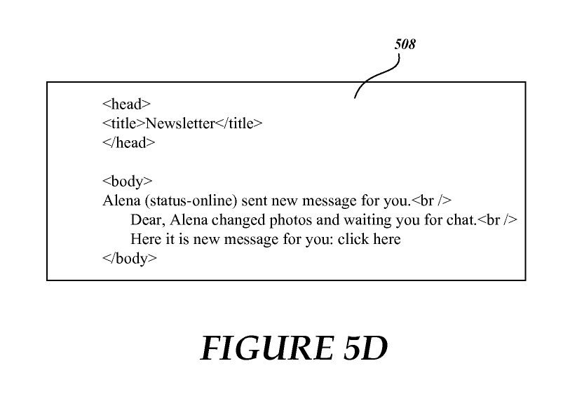

FIGS. 5A-5D depict examples of using messages in part to generate a template for fingerprinting and use in message characterization operations according to an embodiment. In one embodiment, the templates are generated using one or more commonality measures between unwanted messages. As shown in FIGS. 5A-5C, three messages 502-506 have been identified as being relatively similar using a similarity clustering technique and included as part of a production IP block list (or “SEN”). Identified portions of the messages 502-506 are highlighted as shown below the messages where variable HTML/literal portions associated with a first commonality measure are underlined and very common HTML/literal portions associated with a second commonality measure are italicized.

FIG. 5D depicts an unwanted communication template 508 based on the above collection of messages after extracting the identified portions. For this example, all variable HTML/literals have been removed or extracted, along with very common HTML/literals frequently found in a larger set of messages. As discussed above, the unwanted communication template can be fingerprinted, validated, and/or stored as representative of a spam campaign.

FIGS. 6A-6C depict examples of using messages in part to generate a template for fingerprinting and use in message characterization operations according to another embodiment. FIG. 6A depicts a message portion 602 comprising an HTML MIME portion. For example, MIME parts of an e-mail can be extracted using a number of application programming interfaces (APIs) (e.g., publicly available Microsoft Exchange Mime APIs). In one embodiment, custom string parsers can be used to extract all HTML tags/template from the MIME parts of the email. As discussed above, the remaining HTML tags can be used to generate an unwanted communication template by formatting the body of a message excluding the actual contents/text.

FIG. 6B depicts a modified message data structure 604. The modified message data structure 604 can be generated by removing any literals from the text. For example, use a regular expression (?<=\>)[̂\<]+ with string.empty to match any text that falls in between > and <, where ‘>’ represents the end of an HTML tag and ‘>’ represents the beginning, including replacing any matches with an empty string. In one embodiment, the values are removed entirely so that a second regular expression (regex) increases the accuracy of matching HTML tags (implies that anything considered literal can be removed from the HTML). As shown in FIG. 6B, the modified message data structure 604 includes pure tags with properties and members.

FIG. 6C depicts an exemplary template data structure 606 generated from the modified message data structure 604. For example, the template data structure 606 can be generated using a regex (e.g., \>?\s*\<\S+) to extract pure tags from remaining text. Since all literal spaces have been removed for this example, the regex can be used to parse from the condition of a ‘<’ or space until another space is encountered. Accordingly, the alternate approach does not have to extract tag properties, just the base tag by parsing only up until a space is encountered within a tag, and ignoring the remainder. For example (<a href . . . >, would result in extracting the tag as <a>. Once generated, the exemplary template data structure 606 can be fingerprinted and used as part of characterizing unknown messages.

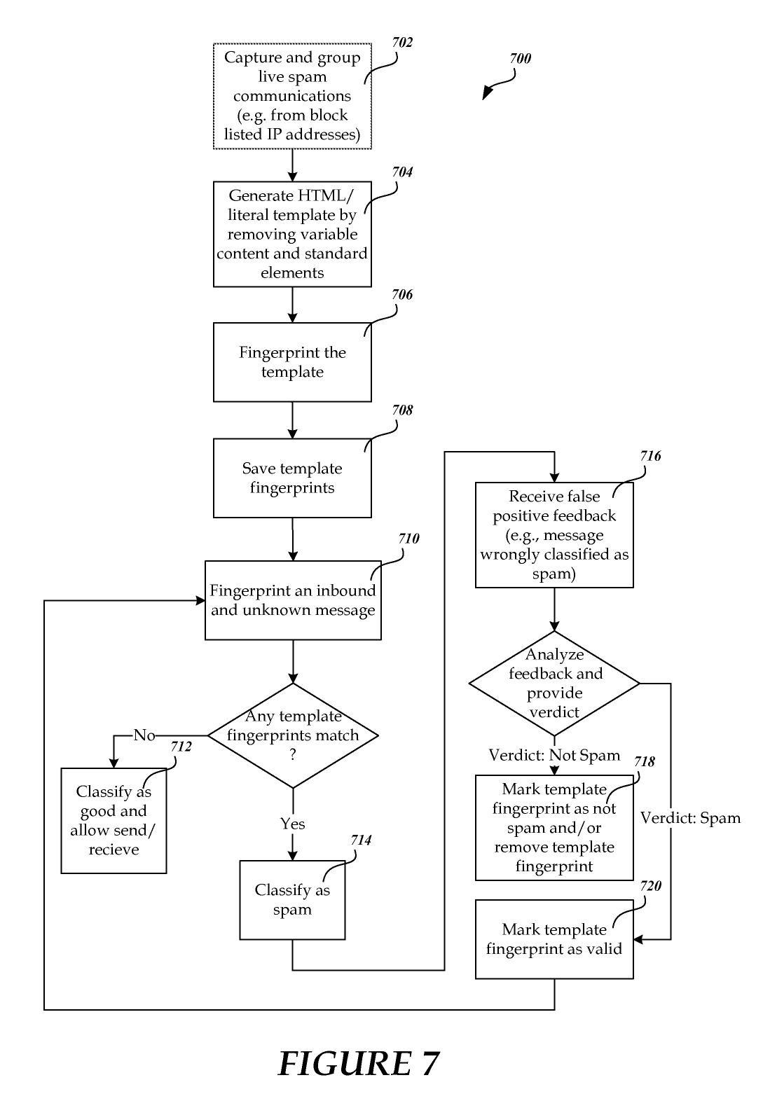

FIG. 7 is a flow diagram depicting an exemplary process 700 of processing and managing unwanted electronic communications. The process 700 at 702 operates to capture and group live spam communications (e.g., e-mails). At 704, the process 700 operates to generate an HTML/literal template by removing variable content and standard elements for the group. At 706, the process 700 operates to fingerprint the HTML and literal template. At 708, the process 700 operates to store generated fingerprints.

At 710, the process 700 operates to fingerprint an inbound and unknown message, generating an unknown message fingerprint. In one embodiment, the process 700 at 710 uses a shingling process, an unknown message (e.g., using all markup and/or content), and a hashing algorithm to generate a corresponding communication fingerprint. If no template fingerprints match the unknown communication fingerprint, the flow proceeds to 712, and the unknown message is classified as good and released. In one embodiment, a regex engine can be used as a second layer of security to process messages classified as good to further ensure that a communication is not spam or unwanted.

If a template fingerprint matches the unknown message, the flow proceeds to 714, and the unknown message is classified as spam and blocked, and the flow proceeds to 716. At 716, the process 700 operates to receive false positive feedback, such as when an e-mail is wrongly classified as spam for example. Based on an analysis of the feedback communication and/or other information, the template fingerprint can be marked as spam related at 718 and continue to be used in unknown message characterization operations. Otherwise, the template fingerprint can be marked as not being spam related at 720 and/or removed from a fingerprint repository and/or reference database. While a certain number and order of operations is described for the exemplary flow of FIG. 7, it will be appreciated that other numbers and/or orders can be used according to desired implementations.

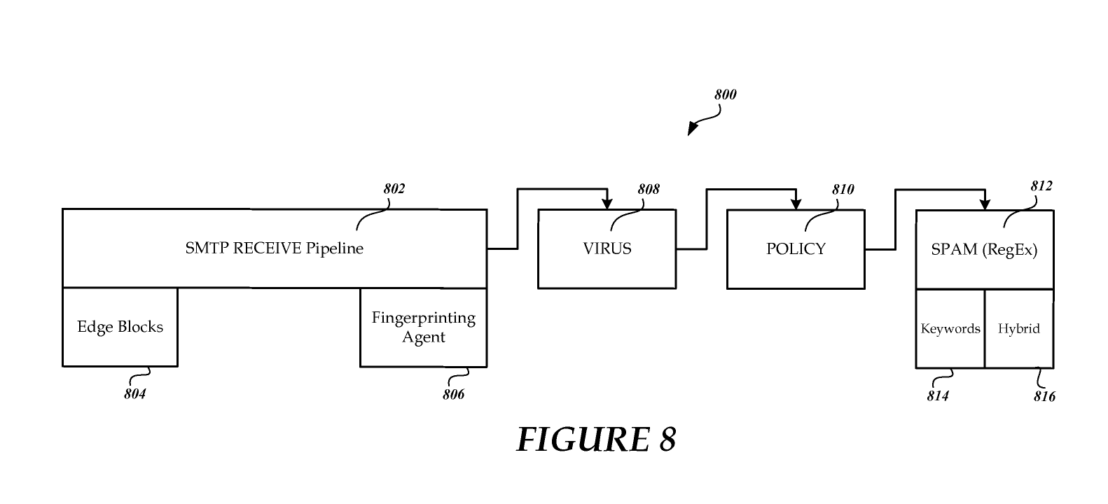

FIG. 8 is a block diagram depicting aspects of an exemplary spam detection system 800. As shown, the exemplary system 800 includes an SMTP receive pipeline 802 including a number of filtering agents used to process messages (e.g., reject or block) before a Forefront Online Protection for Exchange (FOPE) SMTP server accepts such messages and assumes any associated responsibility therewith. The Edge Blocks 804 include components that operate to identify, classify, and/or block messages before accepting the message (e.g., based on the sender IP address). The fingerprinting agent (FPA) 806 can be used to block messages that match a spam template fingerprint (e.g., an HTML/literal template fingerprint).

The Virus component 808 performs basic anti-virus scanning operations and can block delivery if malware is detected. If a message is blocked by the Virus component 808, it may be more expensive to process using FOPE which may include handling sending back non-deliver and/or other notifications, etc. The Policy component 810 performs filtering operations and takes actions on messages based on authored rules (e.g., by customers for example, if it is from one an employee and uses vulgar words, block that message). The SPAM (Regex) component 812 provides anti-spam features and functionalities, such as keywords 814 and hybrid 816 features (Please add detail).

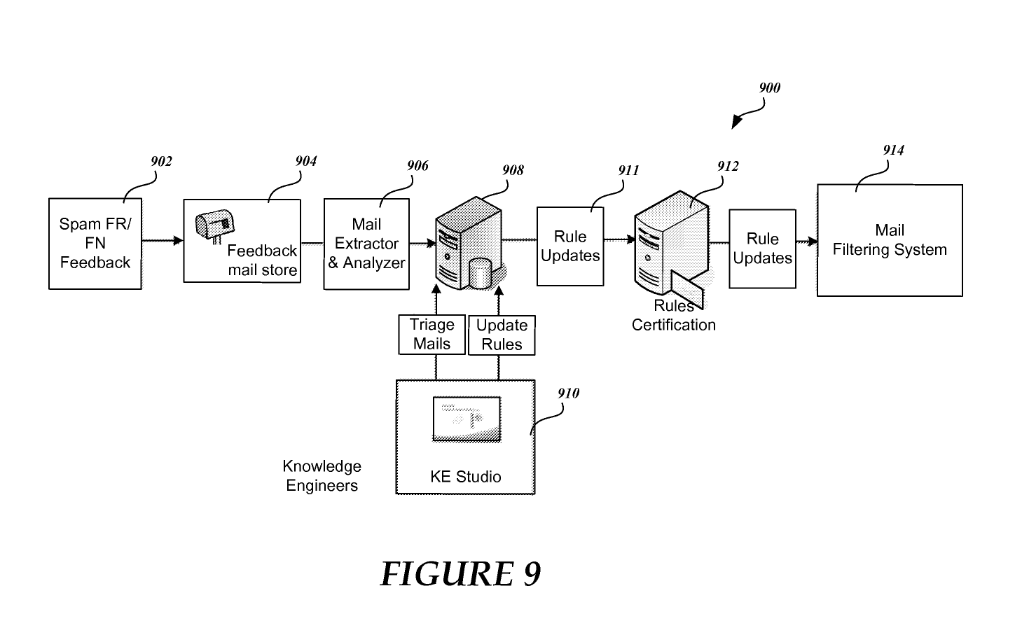

FIG. 9 is a block diagram depicting aspects of an exemplary spam detection system 900. As shown, the exemplary system 900 includes a Spam FP/FN Feedback component 902 represents any number of inputs into a spam remediation pipeline (for example, customers can send e-mails to a specific address; or, end-users can install a junk mail plug-in, etc.). The Feedback Mail Store 904 can be configured as a central repository for false positives and negatives for the anti-spam system.

The Mail Extractor and Analyzer 906 operates to remove a message body and headers for storing in a database. Removing content from the raw message can save processing time later. The extracted content, along with existing anti-spam rules, can be stored in the Mails & Spam Rules Storage component 908. The knowledge engineering (KE) studio component 910 can be used as a spam analysis tool as part of determining whether FP/FN feedback was accurate (for example, routinely incorrectly reporting newsletters as spam). After validating that the messages are truly false positives or false negatives, the Rule Updates component 911 can update anti-spam rules to improve detection accuracy. A Rules Certification component 912 can be used to certify that the updated rules are valid before providing the updated rules to a mail filtering system 914 (e.g., FOPE). For example, rules updates and certification operations can be used to validate that the updated rules (e.g., regular expressions or templates) do not adversely harm the health of a service (e.g., cause a lot of false positives). If the rule passes validation, it can be released to production servers.

While certain embodiments are described herein, other embodiments are available, and the described embodiments should not be used to limit the claims Exemplary communication environments for the various embodiments can include the use of secure networks, unsecure networks, hybrid networks, and/or some other network or combination of networks. By way of example, and not limitation, the environment can include wired media such as a wired network or direct-wired connection, and/or wireless media such as acoustic, radio frequency (RF), infrared, and/or other wired and/or wireless media and components. In addition to computing systems, devices, etc., various embodiments can be implemented as a computer process (e.g., a method), an article of manufacture, such as a computer program product or computer readable media, computer readable storage medium, and/or as part of various communication architectures.

The term computer readable media as used herein may include computer storage media. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of device. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components include, but are not limited to, wide area networks (WANs), local area networks (LANs), metropolitan area networks (MANs), proprietary networks, backend networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions. Other embodiments and configurations are available.

### Exemplary Operating Environment

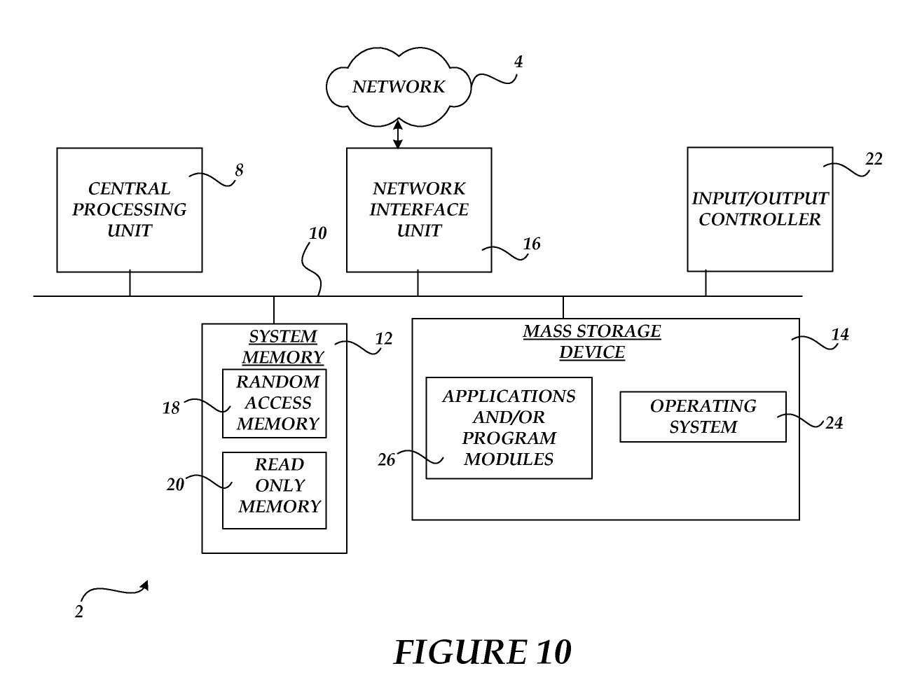

Referring now to FIG. 10, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 10, an illustrative operating environment for embodiments of the invention will be described. As shown in FIG. 10, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules 26.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method comprising:
identifying unwanted communications as known unwanted communications;
removing first portions of the known unwanted communications, wherein the first portions are associated with a first commonality measure;
removing second portions of the known unwanted communications, wherein the second portions are associated with a second commonality measure;
generating a template using remaining portions of the known unwanted communications;
generating a template fingerprint for the template;
generating an unknown communication fingerprint for an unknown communication; and
comparing aspects of the template fingerprint and the unknown communication fingerprint as part of determining whether the unknown communication is an unwanted communication; and
storing the template fingerprints in memory.

2. The method of claim 1, further comprising grouping known unwanted communications according to an identified spamming entity.

3. The method of claim 1, further comprising grouping known unwanted communications according to previously identified spam communications.

4. The method of claim 1, further comprising removing the first portions of the known unwanted communications according to a first grouping of known unwanted communications, wherein the first commonality measure corresponds with little or no commonality for the known unwanted communications of the first grouping.

5. The method of claim 4, further comprising removing the second portions of the known unwanted communications according to a second grouping of communications, wherein the second commonality measure corresponds with a high level of commonality between the second portions of the second grouping.

6. The method of claim 1, further comprising generating the fingerprints using a hashing algorithm.

7. The method of claim 6, further comprising generating the fingerprints using a b-bit minwise hashing algorithm.

8. The method of claim 1, further comprising classifying the unknown communication as spam based in part on a containment coefficient evaluation including using a set of word units of a known spam template and a set of word units of a live message.

9. The method of claim 1, further comprising asymmetrically generating spam templates and associated fingerprints.

10. The method of claim 1, further comprising adding a previously unknown electronic communication fingerprint to a spam fingerprint repository as a spam fingerprint.

11. The method of claim 1, further comprising classifying an active unknown electronic message as spam based in part on a containment coefficient parameter including using a similarity parameter ratio multiplied by a sum of the set of word units in the template and the set of word units in the active unknown electronic message, divided by the set of word units in the template.

12. The method of claim 1, further comprising removing a known spam template fingerprint from a template fingerprint repository to prevent the known spam template fingerprint from being used in future comparisons based in part on a feedback communication.

13. A system comprising:
a template generating component configured to generate electronic templates based in part on aspects of a source communication;
a fingerprinting component configured to generate electronic fingerprints based in part on a hashing technique and aspects of electronic communications including aspects of generated electronic templates classified as spam and at least one other unknown electronic communication;
a characterization component configured to perform characterization operations using electronic fingerprints and a containment coefficient parameter, including using a template fingerprint and an uncharacterized electronic communication fingerprint, as part of vetting unwanted communications; and
memory to store electronic fingerprints classified as known unwanted communications.

14. The system of claim 13, wherein the template generating component is further configured to remove hypertext markup language (HTML) and literals as part of generating the electronic templates.

15. The system of claim 13, further comprising a knowledge manager to manage false positive and negative feedback communications.

16. The system of claim 13, wherein the template generating component is further configured to operate asymmetrically when generating electronic templates from source communications.

17. The system of claim 16, wherein the template generating component is further configured to generate known spam templates using a shingling algorithm, a number of word units, and an extraction technique to extract source communication portions when generating templates.

18. A computer-readable medium, having instructions which, when executed, detect electronic spam communications by:
using portions of identified unwanted communications to generate one or more unwanted communication fingerprints using one or more hashing algorithms;
generating an unknown communication fingerprint from an unknown communication using the one or more hashing algorithms;
comparing aspects of the one or more unwanted communication fingerprints and the unknown communication fingerprint as part of identifying whether the unknown communication is unwanted; and
preventing delivery of the unknown communication when the unknown communication is identified as an unwanted unknown communication.

19. The computer-readable medium of claim 18, having instructions which, when executed, detect electronic spam communications by generating unwanted communication templates based in part on the portions that include first portions having an associated commonality measure and second portions having an associated commonality measure.

20. The computer-readable medium of claim 18, having instructions which, when executed, detect electronic spam communications by using a template fingerprint, a live message fingerprint, and a containment coefficient evaluation to characterize an electronic communication as spam.
